(19) United States
(12) Patent Application Publication
(10) Pub. No.: US 2025/0267106 A1
(43) Pub. Date: Aug. 21, 2025

(54) Methods For Packet Data Convergence Protocol Enhancements On Control Protocol Data Unit For Sequence Number Gap Report

(71) Applicant: MediaTek Inc., Hsinchu City (TW)

(72) Inventors: Ming-Yuan Cheng, Hsinchu City (TW); Pradeep Jose, Cambridge (GB)

(21) Appl. No.: 19/034,620

(22) Filed: Jan. 23, 2025

Related U.S. Application Data
(60) Provisional application No. 63/555,473, filed on Feb. 20, 2024.

(51) Int. Cl. H04L 47/32

(52) U.S. Cl. CPC H04L 47/32

(57) ABSTRACT

Various solutions for packet data convergence protocol (PDCP) enhancements on control protocol data unit (PDU) for sequence number (SN) gap report are described. A transmitting apparatus may obtain one or more PDCP service data units (SDUs) from an upper layer. The transmitting apparatus may detect that the one or more PDCP SDUs, each associated with a PDCP SN, are discarded before successfully transmitted to a receiving apparatus. Then, the transmitting apparatus may transmit a PDCP control PDU to the receiving apparatus. The PDCP control PDU may indicate a PDCP SN gap report associated with the discarded PDCP SDUs.

### CROSS REFERENCE TO RELATED PATENT APPLICATION(S)

The present disclosure is part of a non-provisional application claiming the priority benefit of U.S. Patent Application No. 63/555,473, filed 20 Feb. 2024, the content of which herein being incorporated by reference in its entirety.

### TECHNICAL FIELD

The present disclosure is generally related to mobile communications and, more particularly, to packet data convergence protocol (PDCP) enhancements on control protocol data unit (PDU) for sequence number (SN) gap report.

### BACKGROUND

Unless otherwise indicated herein, approaches described in this section are not prior art to the claims listed below and are not admitted as prior art by inclusion in this section.

PDCP is a (sub)layer specified by 3^{rd} generation partnership project (3GPP) for 4^{th} generation (4G) Long Term Evolution (LTE) or 5^{th} generation (5G) New Radio (NR). In the radio protocol stack of 4G LTE or 5G NR, the PDCP layer is located on top of the radio link control (RLC) layer and below the radio resource control (RRC) layer (on control plane) or Internet protocol (IP) layer (on user plane). From PDCP's perspective, the packet received from the upper layers (e.g., RRC, IP, and/or application (AP) layer) is referred to as a service data unit (SDU) while the packet (after PDCP processing) submitted to the lower layer (e.g., RLC layer) is referred to as a PDU. Generally, the PDCP layer supports processing functions such as transfer of data (user plane and/or control plane), maintenance of PDCP SNs, header/data compression and decompression, ciphering and deciphering, integrity protection and integrity verification, timer-based SDU discard, reordering and in-order delivery, etc.

In current 3GPP standard for PDCP, it is up to UE implementation to minimize SN gap (also called PDCP SN gap) after SDU discard when a discarded PDCP SDU is already associated with a PDCP SN. For the case of a single PDCP SDU being discarded, the UE may be able to handle the SN gap by itself. However, for the case of many PDCP SDUs being discarded, it would be difficult to handle the SN gap solely by the UE itself and the SN gap will cause reordering delay at the receiver side. On top of that, after the feature of PDU set is introduced in Release 18 of the 3GPP standard, the issue with SN gap may get even worse. More specifically, a PDU set contains one or more PDUs carrying the payload of one unit of information generated at the application level, and all PDUs in the PDU set are associated with the same discard timer. FIG. 1 illustrates an example scenario 100 of single SDU discard and PDU set discard. Part (A) of FIG. 1 depicts a single SDU discard while part (B) of FIG. 1 depicts a PDU set discard. When one PDU in the PDU set fails to be successfully delivered to the receiver side before the discard timer expires, the SDUs corresponding to all PDUs in the PDU set will be discarded. FIG. 2 illustrates an example scenario 200 of the issue with SN gap in PDU set discard. As shown in FIG. 2, at the transmitter side, the PDU set discard will cause a relatively large SN gap (e.g., SN gap may range from SN=2 to SN=5), when compared to a single PDU discard. At the receiver side, it is not aware of the SN gap problem and it only relies on the expiration of t-Reordering timer to detect the SN gap. That is, for SN gap detection, the receiver side has to wait for the t-Reordering timer to expire, which results in an undesirable delay (i.e., reordering delay). Furthermore, the issue with SN gap also exists in the case of traffic dispatch on split bearer, as shown in FIG. 3, where the traffic from one PDCP entity may be dispatched to two different RLC entities (or called RLC legs) but imbalance traffic dispatch between these two RLC legs may cause an SN gap since the physical (PHY) capacities of these two RLC legs may be hard to know at run-time and may very likely to be different (e.g., one PHY's capacity is better than another PHY's capacity).

Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and/or apparatus pertaining to PDCP enhancements on control PDU for SN gap report. It is believed that the above-described issue would be avoided or otherwise alleviated by implementing one or more of the proposed schemes described herein.

In one aspect, a method may involve a transmitting apparatus obtaining one or more PDCP SDUs from an upper layer. The method may also involve the transmitting apparatus detecting that the one or more PDCP SDUs, each associated with a PDCP SN, are discarded before successfully transmitted to a receiving apparatus. The method may further involve the transmitting apparatus transmitting a PDCP control PDU to the receiving apparatus, wherein the PDCP control PDU indicates a PDCP SN gap report associated with the discarded PDCP SDUs.

In one aspect, a method may involve a receiving apparatus receiving a PDCP control PDU from a transmitting apparatus, wherein the PDCP control PDU indicates a PDCP SN gap report associated with one or more PDCP SDUs. The method may also involve the receiving apparatus determining the PDCP SDUs as discarded. The method may further involve the receiving apparatus delivering all stored PDCP SDUs and the PDCP SDUs which are determined as discarded to an upper layer.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of single SDU discard and PDU set discard.

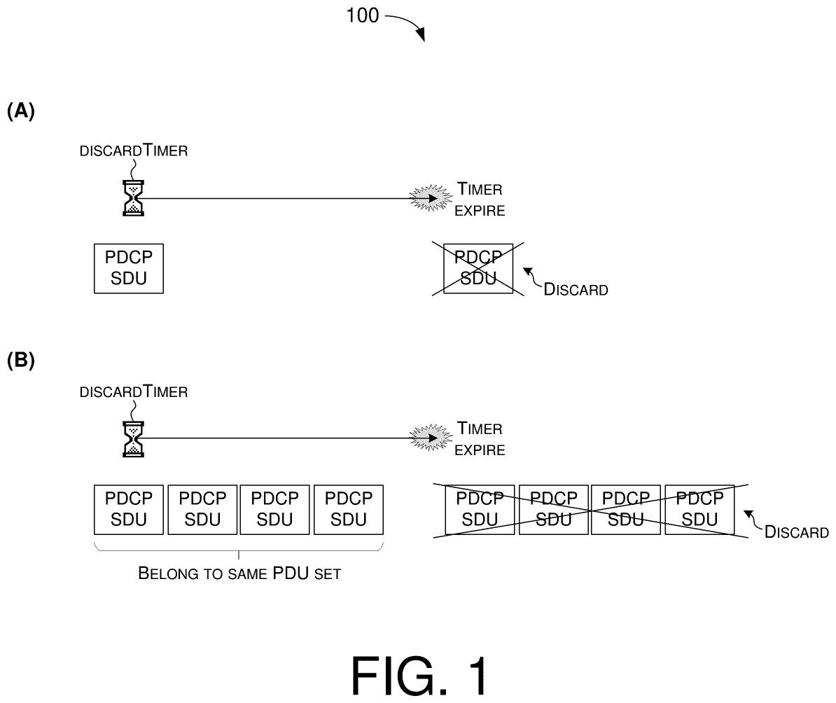

FIG. 2 is a diagram depicting an example scenario of the issue with SN gap in PDU set discard.

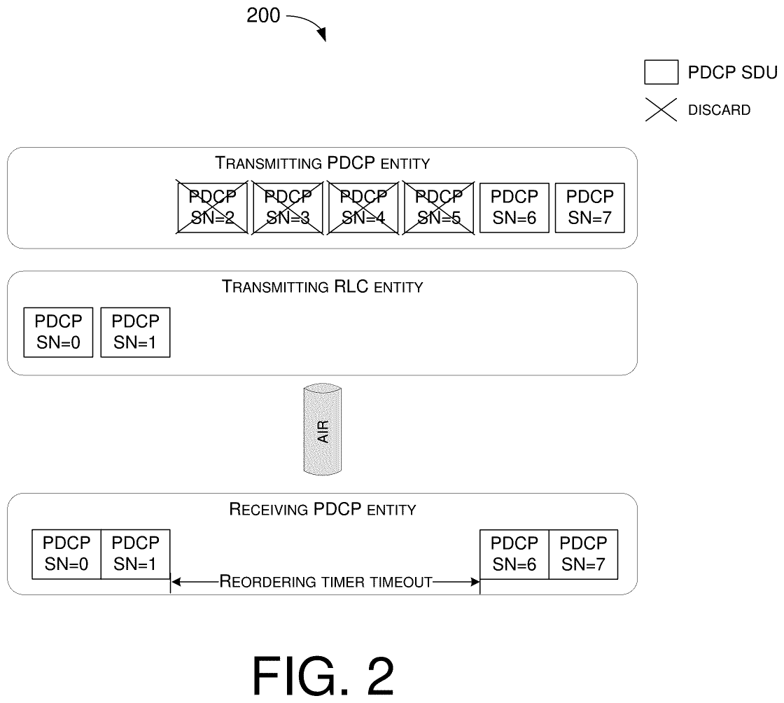

FIG. 3 is a diagram depicting an example scenario of traffic dispatch on split bearer.

FIG. 4 is a diagram depicting an example scenario of a communication environment in which various solutions and schemes in accordance with the present disclosure may be implemented.

FIG. 5 is a diagram depicting an example scenario of PDCP operations at the transmitter side and the receiver side in accordance with an implementation of the present disclosure.

FIG. 6 is a diagram depicting an example scenario of PDCP control PDU for PDCP SN gap report in accordance with an implementation of the present disclosure.

FIG. 7 is a diagram depicting another example scenario of PDCP control PDU for PDCP SN gap report in accordance with an implementation of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to PDCP enhancements on control PDU for SN gap report. According to the present disclosure, a number of possible solutions may be implemented separately or jointly. That is, although these possible solutions may be described below separately, two or more of these possible solutions may be implemented in one combination or another.

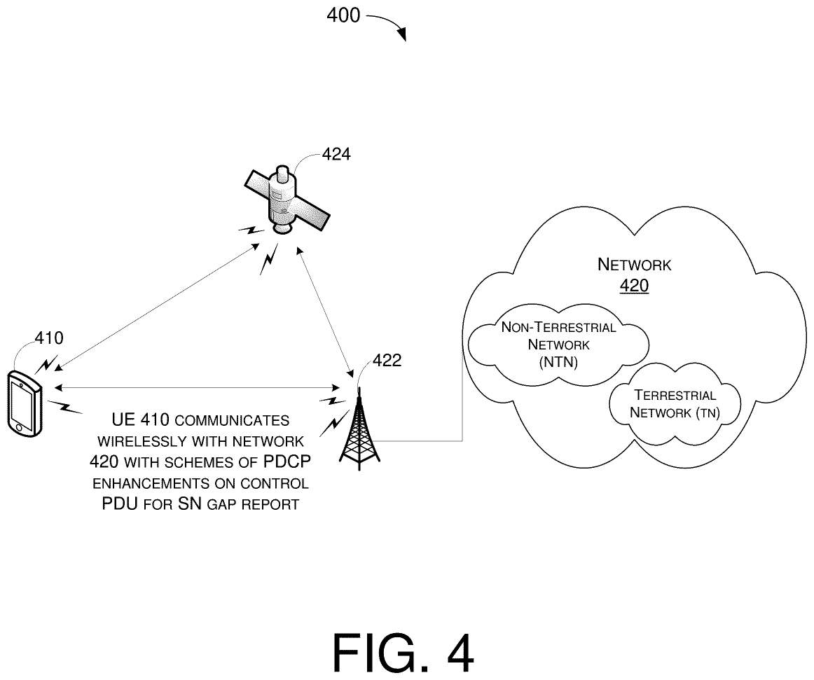

FIG. 4 illustrates an example scenario 400 of a communication environment in which various solutions and schemes in accordance with the present disclosure may be implemented. Scenario 400 involves a UE 410 in wireless communication with a network 420 (e.g., a wireless network including a non-terrestrial network (NTN) and a TN) via at least a terrestrial network node 422 (e.g., a base station (BS) such as an evolved Node-B (eNB), a Next Generation Node-B (gNB), or a transmission/reception point (TRP)) and/or at least a non-terrestrial network node 424 (e.g., a satellite). For example, the terrestrial network node 422 may form a TN serving cell for wireless communication with the UE 410, or the terrestrial network node 422 and/or the non-terrestrial network node 424 may form an NTN serving cell for wireless communication with the UE 410. In some implementations, the network 420 may be a 4G/5G/B5G/6G network, and the UE 410 may be a smartphone, a tablet computer, a laptop computer or a notebook computer. Alternatively, the network 420 may be an IoT/NB-IoT/IIoT network, and the UE 410 may be an IoT device such as an NB-IoT UE or an enhanced machine-type communication (eMTC) UE (e.g., a bandwidth reduced low complexity (BL) UE or a coverage enhancement (CE) UE). In such communication environment, the UE 410, the network 420, the terrestrial network node 422, and/or the non-terrestrial network node 424 may implement various schemes pertaining to PDCP enhancements on control PDU for SN gap report in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Under current 5G NR framework, it is up to UE implementation to minimize SN gap after SDU discard when a discarded PDCP SDU is already associated with a PDCP SN. However, as above-described, for the case of many PDCP SDUs (e.g., PDU set(s)) being discarded and/or the case of traffic dispatch on split bearer, the SN gap created at the transmitter side will cause reordering delay at the receiver side. Consequently, the reordering delay will impact the application level throughput and user experience.

In view of the above, the present disclosure proposes a number of schemes pertaining to PDCP enhancements on control PDU for SN gap report. According to the schemes of the present disclosure, a new PDCP control PDU specific for PDCP SN gap report is provided, along with corresponding transmit and receive operations. Accordingly, the transmitter side (e.g., the transmitting PDCP entity in a BS for downlink scenarios, or the transmitting PDCP entity in a UE for uplink scenarios) may be allowed to transmit the new PDCP control PDU when detecting a PDCP SN gap with discarded PDCP SDU(s), such that the receiver side (e.g., the receiving PDCP entity in a UE for downlink scenarios, or the receiving PDCP entity in a BS for uplink scenarios) may be timely notified of the PDCP SN gap to eliminate the reordering delay.

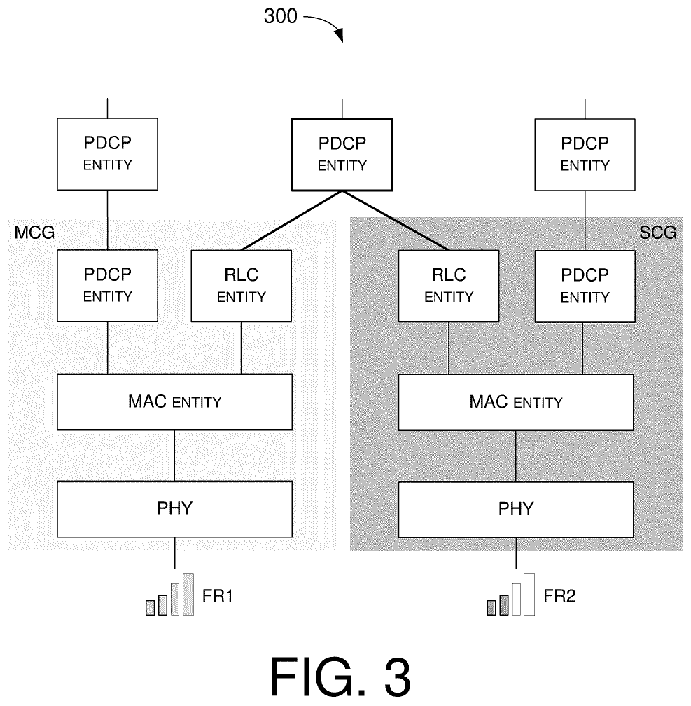

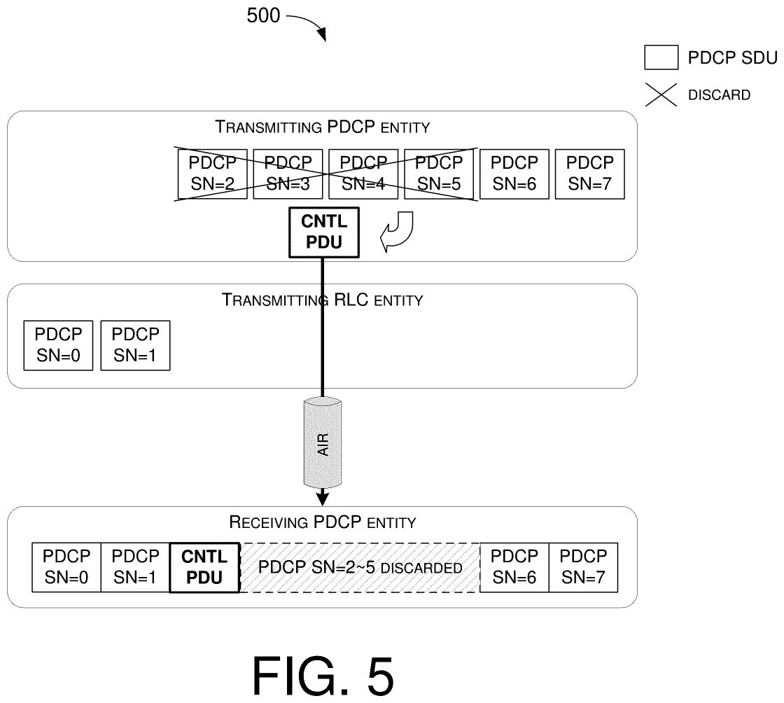

FIG. 5 illustrates an example scenario 500 of PDCP operations at the transmitter side and the receiver side in accordance with an implementation of the present disclosure. As shown in FIG. 5, when detecting that PDCP SDU(s) already associated with PDCP SN is/are discarded, the transmitter side may transmit the PDCP control PDU for PDCP SN gap report to the receiver side to indicate a PDCP SN gap report associated with the discarded PDCP SDUs (denoted with PDCP SN=2 to 5). When receiving the PDCP control PDU, the receiver side may consider the indicated PDCP SDU(s) in the PDCP control PDU as discarded (i.e., the transmitter will not transmit these PDCP SDUs anymore). Then, the receiver side may deliver all stored PDCP SDUs and the PDCP SDUs which are considered as discarded to upper layers (e.g., RRC, IP, and/or AP layer), and update corresponding state variables (e.g., RX_NEXT, RX_DELIV, and/or RX_REORD). Additionally, or optionally, the receiver side may stop and reset the t-Reordering timer. It is noteworthy that there is almost no reordering delay (or only a small reordering delay) at the receiver side due to the notification by the new PDCP control PDU. Although scenario 500 depicts the case of one-to-one mapping between the PDCP entity and the RLC entity, the proposed schemes of the present disclosure may also apply to the case of traffic dispatch on split bearer (i.e., one PDCP entity is mapped to or associated with two or more RLC entities, similar to scenario 300 of FIG. 3).

More specifically, the new PDCP control PDU may indicate the PDCP SN gap report by including at least an indication of the PDCP SN of the first discarded PDCP SDU. Additionally, or optionally, the new PDCP control PDU may further indicate the PDCP SN gap report by including an extra indication of the PDCP SNs of the following discarded PDCP SDUs.

In some implementations, the indication of the PDCP SN of the first discarded PDCP SDU may be a first discard count (FDC), i.e., the COUNT value of the first discarded PDCP SDU within the reordering window. The COUNT value is composed of a hyper frame number (HFN) and the PDCP SN. The size of the HFN part in bits is equal to 32 minus the length of the PDCP SN.

In some implementations, the indication of the PDCP SN of the first discarded PDCP SDU may be the PDCP SN itself of the first discarded PDCP SDU. The length of the PDCP SN is 12 bits (e.g., for signaling radio bearers (SRBs), unacknowledged mode (UM) data radio bearers (DRBs), acknowledged mode (AM) DRBs (including sidelink SRBs and sidelink DRBs), UM multicast radio bearers (MRBs) and AM MRBs) or 18 bits (e.g., for UM DRBs, AM DRBs (including sidelink DRBs for unicast), UM MRBs and AM MRBs).

In some implementations, the extra indication of the PDCP SNs of the following discarded PDCP SDUs may be a discard bitmap indicating which PDCP SDUs are discarded and which PDCP SDUs are not discarded in the transmitter side.

In some implementations, the extra indication of the PDCP SNs of the following discarded PDCP SDUs may be the COUNT value of the last discarded PDCP SDU, with an assumption that the discarded PDCP SDUs (e.g., belonging to the same PDU set) are associated with consecutive PDCP SNs.

In some implementations, the extra indication of the PDCP SNs of the following discarded PDCP SDUs may be the number of the discarded PDCP SDUs.

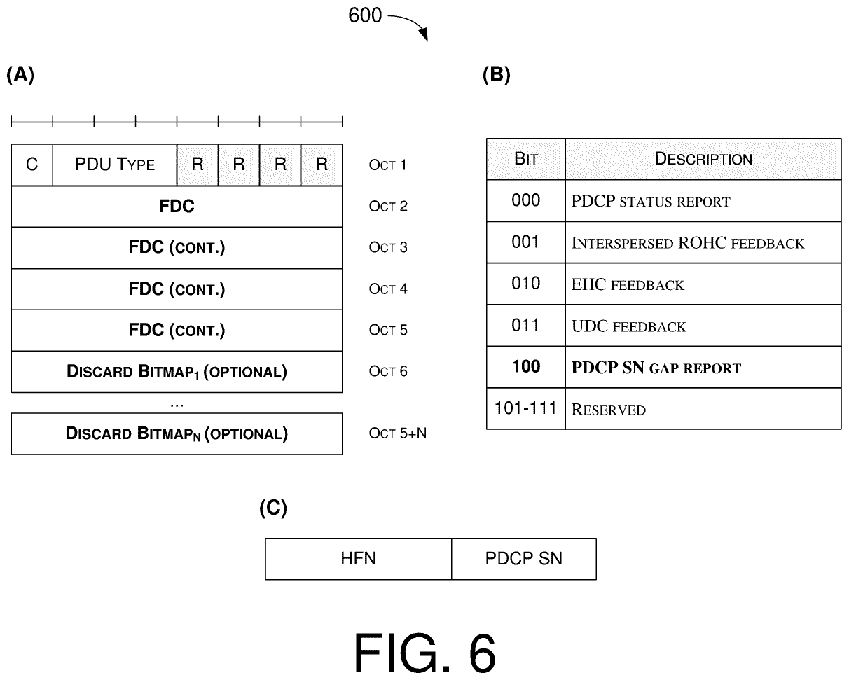

FIG. 6 illustrates an example scenario 600 of PDCP control PDU for PDCP SN gap report in accordance with an implementation of the present disclosure. Part (A) of FIG. 6 depicts the format of the PDCP control PDU for PDCP SN gap report. Part (B) of FIG. 6 depicts the interpretation of the value of the PDU type. Part (C) of FIG. 6 depicts the format of the FDC field. Specifically, the new PDCP control PDU may contain: (i) a PDU type with a value (e.g., bit value=‘100’) for PDCP SN gap report, (ii) a FDC indicating the smallest COUNT value among the COUNT values associated with the discarded PDCP SDUs, and (iii) a discard bitmap indicating which PDCP SDUs are discarded and which PDCP SDUs are not discarded in the transmitter side.

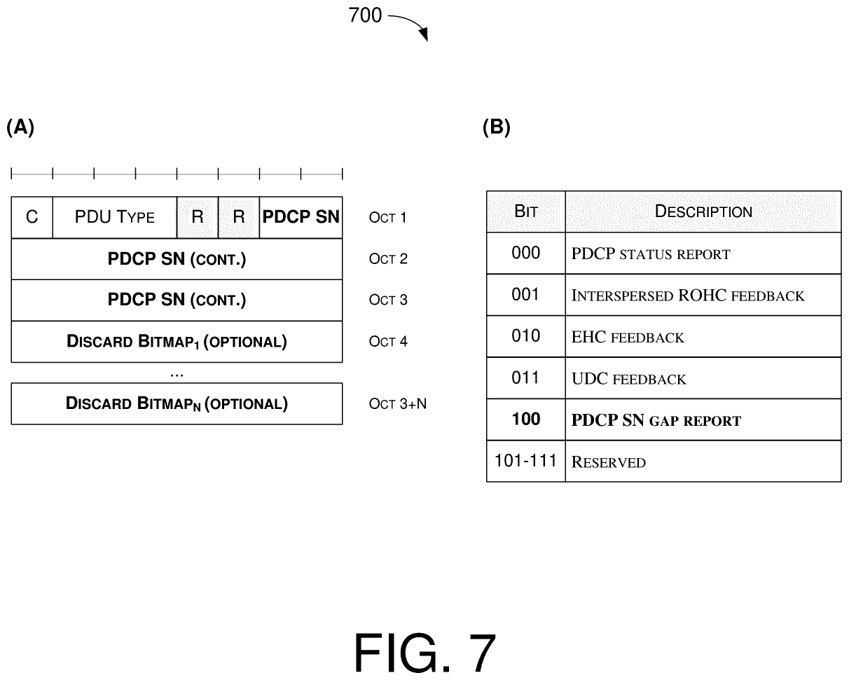

FIG. 7 illustrates an example scenario 700 of PDCP control PDU for PDCP SN gap report in accordance with an implementation of the present disclosure. Part (A) of FIG. 7 depicts the format of the PDCP control PDU for PDCP SN gap report for data radio bearers (DRBs) with 18 bits PDCP SN. Part (B) of FIG. 7 depicts the interpretation of the value of the PDU type. Specifically, the new PDCP control PDU may contain: (i) a PDU type with a value (e.g., bit value=‘100’) for PDCP SN gap report, (ii) a PDCP SN indicating the smallest PDCP SN among the PDCP SNs associated with the discarded PDCP SDUs, and (iii) a discard bitmap indicating which PDCP SDUs are discarded and which PDCP SDUs are not discarded in the transmitter side.

### Illustrative Implementations

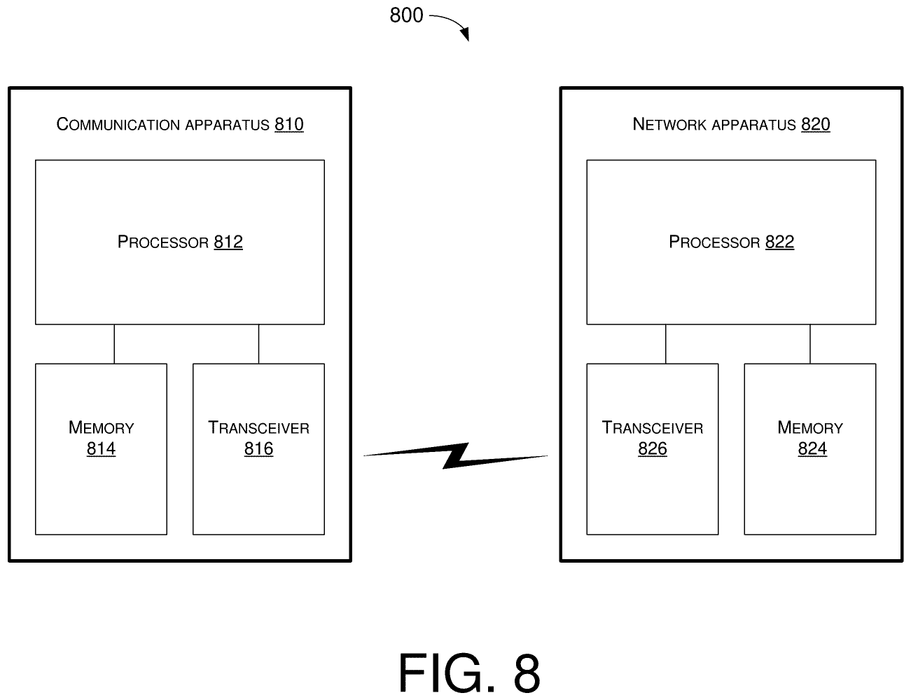

FIG. 8 illustrates an example communication system 800 having an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to PDCP enhancements on control PDU for SN gap report, including scenarios/schemes described above as well as processes 900 and 1000 described below.

Communication apparatus 810 may be a part of an electronic apparatus, which may be a dual-steer device containing one or more UEs such as a portable or mobile apparatus, a wearable apparatus, a wireless communication apparatus or a computing apparatus. For instance, communication apparatus 810 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 810 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example. Communication apparatus 810 may further include one or more other components not pertinent to the proposed schemes of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of an electronic apparatus, which may be a network node such as a satellite, a BS, a small cell, a router, or a gateway of a 4G/5G/B5G/6G, NR, IoT, NB-IoT or IIoT network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks, including radio protocol stack operations (e.g., PDCP operations), in a device (e.g., as represented by communication apparatus 810) and a network node (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In some implementations, transceiver 816 may be capable of wirelessly communicating with different types of UEs and/or wireless networks of different RATs. In some implementations, transceiver 816 may be equipped with a plurality of antenna ports (not shown) such as, for example, four antenna ports. That is, transceiver 816 may be equipped with multiple transmit antennas and multiple receive antennas for multiple-input multiple-output (MIMO) wireless communications. In some implementations, network apparatus 820 may also include a transceiver 826 coupled to processor 822. Transceiver 826 may include a transceiver capable of wirelessly transmitting and receiving data. In some implementations, transceiver 826 may be capable of wirelessly communicating with different types of UEs of different RATs. In some implementations, transceiver 826 may be equipped with a plurality of antenna ports (not shown) such as, for example, four antenna ports. That is, transceiver 826 may be equipped with multiple transmit antennas and multiple receive antennas for MIMO wireless communications.

In some implementations, communication apparatus 810 may further include a memory 814 coupled to processor 812 and capable of being accessed by processor 812 and storing data therein. In some implementations, network apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 810 and network apparatus 820 may be a communication entity capable of communicating with each other using various proposed schemes in accordance with the present disclosure. For illustrative purposes and without limitation, a description of capabilities of communication apparatus 810, as a UE, and network apparatus 820, as a network node (e.g., BS), is provided below with processes 900 and 1000.

### Illustrative Processes

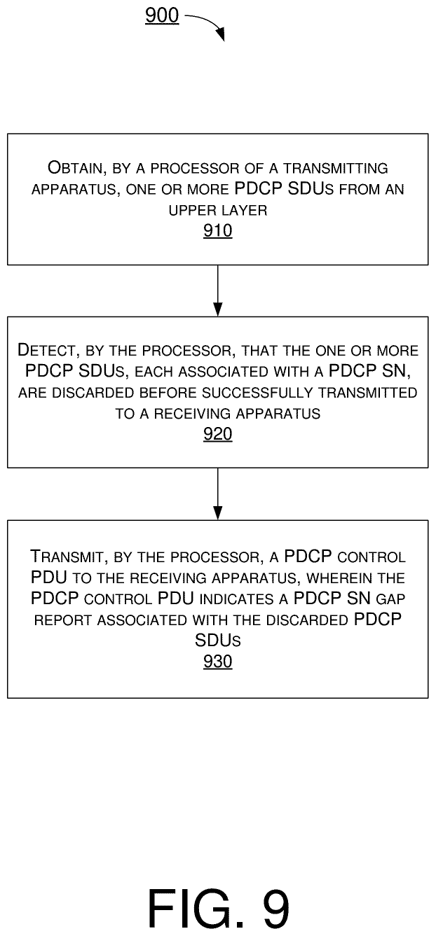

FIG. 9 illustrates an example process 900 in accordance with an implementation of the present disclosure. Process 900 may be an example implementation of above scenarios/schemes, whether partially or completely, with respect to PDCP enhancements on control PDU for SN gap report. Process 900 may represent an aspect of implementation of features of network apparatus 820 for downlink scenarios or communication apparatus 810 for uplink scenarios. Process 900 may include one or more operations, actions, or functions as illustrated by one or more of blocks 910 to 930. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by or in network apparatus 820 or communication apparatus 810 (or any suitable UE or machine type device) as well as any variations thereof. Solely for illustrative purposes and without limiting the scope, process 900 is described below in the context of network apparatus 820, as a transmitting apparatus (e.g., BS), and communication apparatus 810, as a receiving apparatus (e.g., UE) for downlink scenarios, or in the context of communication apparatus 810, as a transmitting apparatus (e.g., UE), and network apparatus 820, as a receiving apparatus (e.g., BS) for uplink scenarios. Process 900 may begin at block 910.

At 910, process 900 may involve processor 822/812 of a transmitting apparatus (e.g., network/communication apparatus 820/810) obtaining one or more PDCP SDUs from an upper layer (e.g., RRC, IP, or AP layer). Process 900 may proceed from 910 to 920.

At 920, process 900 may involve processor 822/812 detecting that the one or more PDCP SDUs, each associated with a PDCP SN, are discarded before successfully transmitted to a receiving apparatus (e.g., communication/network apparatus 810/820). Process 900 may proceed from 920 to 930.

At 930, process 900 may involve processor 822/812 transmitting, via transceiver 826/816, a PDCP control PDU to the receiving apparatus (e.g., communication/network apparatus 810/820), wherein the PDCP control PDU indicates a PDCP SN gap report associated with the discarded PDCP SDUs.

In some implementations, the PDCP control PDU may include a PDU type with a value for the PDCP SN gap report.

In some implementations, the PDCP control PDU may include a FDC indicating a smallest count value among the count values associated with the discarded PDCP SDUs.

In some implementations, the PDCP control PDU may further include a discard bitmap indicating which PDCP SDUs are discarded and which PDCP SDUs are not discarded in the transmitting apparatus.

In some implementations, each of the count values associated with the discarded PDCP SDUs may include an HFN and the PDCP SN.

In some implementations, process 900 may involve processor 822/812 starting a discard timer upon obtaining one of the PDCP SDUs from the upper layer, wherein the PDCP SDUs are discarded along with corresponding PDCP data PDUs in an event that the discard timer expires for the one PDCP SDU and all of the PDCP SDUs belong to a PDU set to which the one PDCP SDU belongs.

In some implementations, the corresponding PDCP data PDUs in the PDU set may include a payload of one unit of information generated at an application level.

In some implementations, the information may include one or more frames or video slices for an extended reality (XR) service.

In some implementations, the PDCP SDUs may be processed by a PDCP entity associated with two RLC entities.

In some implementations, the transmitting apparatus and the receiving apparatus may include a network node (e.g., BS) and a UE.

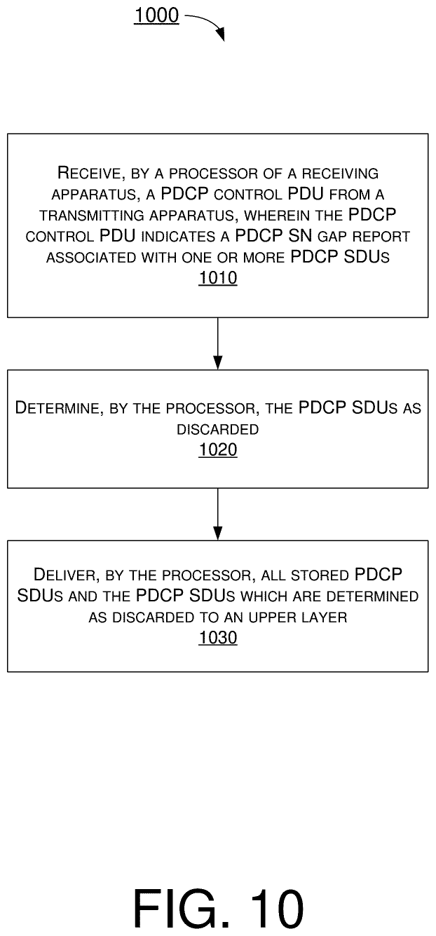

FIG. 10 illustrates an example process 1000 under schemes in accordance with an implementation of the present disclosure. Process 1000 may represent an aspect of implementing various proposed designs, concepts, schemes, systems and methods described above, whether partially or entirely, with respect to PDCP enhancements on control PDU for SN gap report. Process 1000 may represent an aspect of implementation of features of communication apparatus 810 for downlink scenarios or network apparatus 820 for uplink scenarios. Process 1000 may include one or more operations, actions, or functions as illustrated by one or more of blocks 1010 to 1030. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively, in a different order. Process 1000 may be implemented by or in communication apparatus 810 (or any suitable UE or machine type device) or network apparatus 820 as well as any variations thereof. Solely for illustrative purposes and without limiting the scope, process 1000 is described below in the context of communication apparatus 810, as a receiving apparatus (e.g., UE), and network apparatus 820, as a transmitting apparatus (e.g., BS) for downlink scenarios, or in the context of network apparatus 820, as a receiving apparatus (e.g., BS), and communication apparatus 810, as a transmitting apparatus (e.g., UE) for uplink scenarios. Process 1000 may begin at block 1010.

At 1010, process 1000 may involve processor 812/822 of a receiving apparatus (e.g., communication/network apparatus 810/820) receiving, via transceiver 816/826, a PDCP control PDU from a transmitting apparatus (e.g., network/communication apparatus 820/810), wherein the PDCP control PDU indicates a PDCP SN gap report associated with one or more PDCP SDUs. Process 1000 may proceed from 1010 to 1020.

At 1020, process 1000 may involve processor 812/822 determining the PDCP SDUs as discarded. Process 1000 may proceed from 1020 to 1030.

At 1030, process 1000 may involve processor 812/822 delivering all stored PDCP SDUs and the PDCP SDUs which are determined as discarded to an upper layer.

In some implementations, the PDCP control PDU may include a PDU type with a value for the PDCP SN gap report.

In some implementations, the PDCP control PDU may include a FDC indicating a smallest count value among the count values associated with the PDCP SDUs which are determined as discarded.

In some implementations, the PDCP control PDU may further include a discard bitmap indicating which PDCP SDUs are discarded and which PDCP SDUs are not discarded in the transmitting apparatus.

In some implementations, each of the count values associated with the PDCP SDUs may include an HFN and a PDCP SN.

In some implementations, process 1000 may involve processor 812/822 updating PDCP state variables, and stopping and resetting a reordering timer.

In some implementations, one or more PDCP data PDUs corresponding to the PDCP SDUs may belong to a PDU set and include a payload of one unit of information generated at an application level.

In some implementations, the information may include one or more frames or video slices for an XR service.

In some implementations, the PDCP SDUs may be processed by a PDCP entity associated with two RLC entities.

In some implementations, the transmitting apparatus and the receiving apparatus may include a network node (e.g., BS) and a UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
obtaining, by a processor of a transmitting apparatus, one or more packet data convergence protocol (PDCP) service data units (SDUs) from an upper layer;
detecting, by the processor, that the one or more PDCP SDUs, each associated with a PDCP sequence number (SN), are discarded before successfully transmitted to a receiving apparatus; and
transmitting, by the processor, a PDCP control protocol data unit (PDU) to the receiving apparatus, wherein the PDCP control PDU indicates a PDCP SN gap report associated with the discarded PDCP SDUs.

2. The method of claim 1, wherein the PDCP control PDU comprises a PDU type with a value for the PDCP SN gap report.

3. The method of claim 1, wherein the PDCP control PDU comprises a first discard count (FDC) indicating a smallest count value among the count values associated with the discarded PDCP SDUs.

4. The method of claim 3, wherein the PDCP control PDU further comprises a discard bitmap indicating which PDCP SDUs are discarded and which PDCP SDUs are not discarded in the transmitting apparatus.

5. The method of claim 3, wherein each of the count values associated with the discarded PDCP SDUs comprises a hyper frame number (HFN) and the PDCP SN.

6. The method of claim 1, further comprising:
starting, by the processor, a discard timer upon obtaining one of the PDCP SDUs from the upper layer,
wherein the PDCP SDUs are discarded along with corresponding PDCP data PDUs in an event that the discard timer expires for the one PDCP SDU and all of the PDCP SDUs belong to a PDU set to which the one PDCP SDU belongs.

7. The method of claim 6, wherein the corresponding PDCP data PDUs in the PDU set comprise a payload of one unit of information generated at an application level.

8. The method of claim 7, wherein the information comprises one or more frames or video slices for an extended reality (XR) service.

9. The method of claim 1, wherein the PDCP SDUs are processed by a PDCP entity associated with two radio link control (RLC) entities.

10. The method of claim 1, wherein the transmitting apparatus and the receiving apparatus comprise a network node and a user equipment (UE).

11. A method, comprising:
receiving, by a processor of a receiving apparatus, a packet data convergence protocol (PDCP) control protocol data unit (PDU) from a transmitting apparatus, wherein the PDCP control PDU indicates a PDCP SN gap report associated with one or more PDCP service data units (SDUs);
determining, by the processor, the PDCP SDUs as discarded; and
delivering, by the processor, all stored PDCP SDUs and the PDCP SDUs which are determined as discarded to an upper layer.

12. The method of claim 11, wherein the PDCP control PDU comprises a PDU type with a value for the PDCP SN gap report.

13. The method of claim 11, wherein the PDCP control PDU comprises a first discard count (FDC) indicating a smallest count value among the count values associated with the PDCP SDUs which are determined as discarded.

14. The method of claim 13, wherein the PDCP control PDU further comprises a discard bitmap indicating which PDCP SDUs are discarded and which PDCP SDUs are not discarded in the transmitting apparatus.

15. The method of claim 13, wherein each of the count values associated with the PDCP SDUs comprises a hyper frame number (HFN) and a PDCP SN.

16. The method of claim 11, further comprising:
updating, by the processor, PDCP state variables; and
stopping and resetting, by the processor, a reordering timer.

17. The method of claim 11, wherein one or more PDCP data PDUs corresponding to the PDCP SDUs belong to a PDU set and comprise a payload of one unit of information generated at an application level.

18. The method of claim 17, wherein the information comprises one or more frames or video slices for an extended reality (XR) service.

19. The method of claim 11, wherein the PDCP SDUs are processed by a PDCP entity associated with two radio link control (RLC) entities.

20. The method of claim 11, wherein the transmitting apparatus and the receiving apparatus comprise a network node and a user equipment (UE).
